(19) United States
(12) Patent Application Publication
(10) Pub. No.: US 2009/0188681 A1
(43) Pub. Date: Jul. 30, 2009

(54) Powder agitating device for fire extinguisher

(76) Inventor: Ming Tung Chang, Taichung (TW)

Correspondence Address: CHARLES E. BAXLEY, ESQUIRE, 90 JOHN STREET, SUITE 309, NEW YORK, NY, 10038, US

(21) Appl. No.: 12/012,192

(22) Filed: Jan. 30, 2008

(51) Int. Cl. A62C 13/00

(52) U.S. Cl. 169/30; 366/343

(57) ABSTRACT

A fire extinguisher includes a container having a chamber for receiving a dry chemical agent, a cover attached to the container and having a passage for allowing the dry chemical agent to flow out of the cover, and an agitating device received in the container for agitating the dry chemical agent and for preventing the dry extinguishing agent from being hardened. A rod is rotatably received in the container and extended out of the container and includes an agitator, and a hand wheel is secured to the rod for rotating the rod and the agitator relative to the container. A carrier is rotatably attached to a seat for supporting the container and for adjustably securing the container to the seat at selected angular positions.

### BACKGROUND OF THE INVENTION

1. Field of the Invention

The present invention relates to a fire extinguisher, and more particularly to a fire extinguisher including an agitating or stirring device for agitating or stirring the powder or dry extinguishing agent and for preventing the dry extinguishing agent from being hardened into a hardened piece or block and for allowing the dry extinguishing agent to be maintained in a readily working condition or status.

2. Description of the Prior Art

Typical fire extinguishers comprise a container for receiving a powder or dry chemical agent, and a bottle for receiving a compressed gas which may be supplied to dispense the dry chemical agent or to fluidize the dry chemical agent and to carry the dry chemical agent to a hand manipulated nozzle which is aimed at the fire.

For example, U.S. Pat. No. 4,650,004 to Wendling et al. discloses one of the typical portable dry chemical fire extinguishers also comprising a pressurized port container for receiving a powder or dry chemical agent, and a bottle for receiving a compressed gas which may be supplied to carry and to dispense the dry chemical agent.

However, the powder or the dry chemical agent may become hardened after a period of time and thus may not be suitably dispensed or agitated or carried by the compressed gas, and the typical fire extinguishers failed to provide an agitating or stirring device for agitating or stirring the powder or dry extinguishing agent and for preventing the powder or dry extinguishing agent from being hardened.

U.S. Pat. No. 5,275,243 to Williams et al. discloses another typical dry powder and liquid method and apparatus for extinguishing fire by simultaneously applying a spray of dry powder and liquid/liquid-foam.

However, similarly, the typical dry powder and liquid method and apparatus also failed to provide an agitating or stirring device for agitating or stirring the powder or dry extinguishing agent and for preventing the powder or dry extinguishing agent from being hardened.

The present invention has arisen to mitigate and/or obviate the afore-described disadvantages of the conventional fire extinguishers.

### SUMMARY OF THE INVENTION

The primary objective of the present invention is to provide a fire extinguisher including an agitating or stirring device for agitating or stirring the dry extinguishing agent and for preventing the dry extinguishing agent from being hardened into a hardened block and for allowing the dry extinguishing agent to be maintained in a readily working condition or status.

In accordance with one aspect of the invention, there is provided a fire extinguisher comprising a container including a chamber formed therein for receiving a dry chemical agent therein, a cover attached to an upper portion of the container and including a passage formed therein for allowing the dry chemical agent to flow out through the passage of the cover, and an agitating device received in the chamber of the container for agitating the dry chemical agent and for preventing the dry extinguishing agent from being hardened into a hardened block and for allowing the dry extinguishing agent to be maintained in a readily working condition or status.

The agitating device includes a rod rotatably received in the chamber of the container, and the rod is partially extended out of the container, and a hand wheel secured to the rod for rotating the rod relative to the container and the cover. The agitating device includes an agitator attached to the rod for being rotated by the hand wheel to agitate the dry chemical agent.

The rod includes a bore formed therein, and includes an aperture formed therein and communicating with the bore of the rod for allowing the dry chemical agent to flow through the aperture and into the bore of the rod.

The cover includes a conduit formed therein for attaching an upper portion of the rod, and the conduit of the cover is communicating with the passage of the cover for allowing the dry chemical agent to flow out through the conduit and the passage of the cover.

The cover includes an orifice formed therein and communicating with the conduit for receiving a valve member. The valve member is rotatably received in the orifice of the cover and includes a groove formed therein for engaging with the cover and for adjusting a flowing of the dry chemical agent out through the passage of the cover.

The cover includes a hand grip extended therefrom, and includes a space formed in the hand grip, and includes a channel formed in the cover and communicating with the chamber of the container and the space of the hand grip, and a bottle for receiving a compressed gas includes a mouth attached to the space of the hand grip with for supplying the compressed gas to the space of the hand grip and the channel of the hand grip and the chamber of the container.

A check valve is further be provided and disposed in the channel of the hand grip to limit the compressed gas to flow from the bottle to the chamber of the container. The bottle includes a membrane attached to the mouth, and a piercing member is slidably engaged into the space of the hand grip and extended toward the membrane of the bottle for selectively piercing the membrane of the bottle and for allowing the compressed gas to selectively flow out of the bottle.

An actuating member is further be provided and pivotally coupled to the cover with a pivot axle and engaged with the piercing member for actuating the piercing member to pierce the membrane of the bottle.

A cap is further be provided and pivotally coupled to the hand grip with the pivot axle for shielding and protecting the actuating member and for preventing the actuating member from being operated inadvertently.

In accordance with another aspect of the invention, there is provided a fire extinguisher comprising a seat including at least one first engaging member provided therein, a container including a chamber formed therein for receiving a dry chemical agent therein, a cover attached to the container and including a passage formed therein for allowing the dry chemical agent to flow out through the passage of the cover, and a carrier rotatably attached to the seat with a shaft and including a space formed therein for receiving the container, and including a number of second engaging member provided around the shaft for engaging with the first engaging member of the seat and for adjustably securing the carrier and the container to the seat at selected angular positions and for allowing the lower or bottom portion of the container to be exposed or to be reached.

The carrier includes a lower casing and two arms for forming the space of the carrier. The carrier includes an upwardly extending shield having at least one catch for engaging with the cover and for securing the cover to the carrier.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a fire extinguisher in accordance with the present invention;

FIG. 2 is a side plan schematic view of the fire extinguisher;

FIG. 3 is a cross sectional view of the fire extinguisher;

FIG. 4 is a cross sectional view similar to FIG. 3, illustrating the operation of the fire extinguisher;

FIG. 5 is an end schematic view of the fire extinguisher, in which a portion of the fire extinguisher has been cut off for showing the inner structure of the fire extinguisher;

FIG. 6 is another partial exploded view, as shown from the front portion of a carrier, illustrating the carrier for the fire extinguisher;

FIG. 7 is a further partial exploded view, as shown from the rear portion of the carrier for the fire extinguisher; and

FIG. 8 is a another side plan schematic view illustrating the operation of the carrier for adjustably supporting the container of the fire extinguisher.

### DETAILED DESCRIPTION OF THE PREFERRED EMBODIMENT

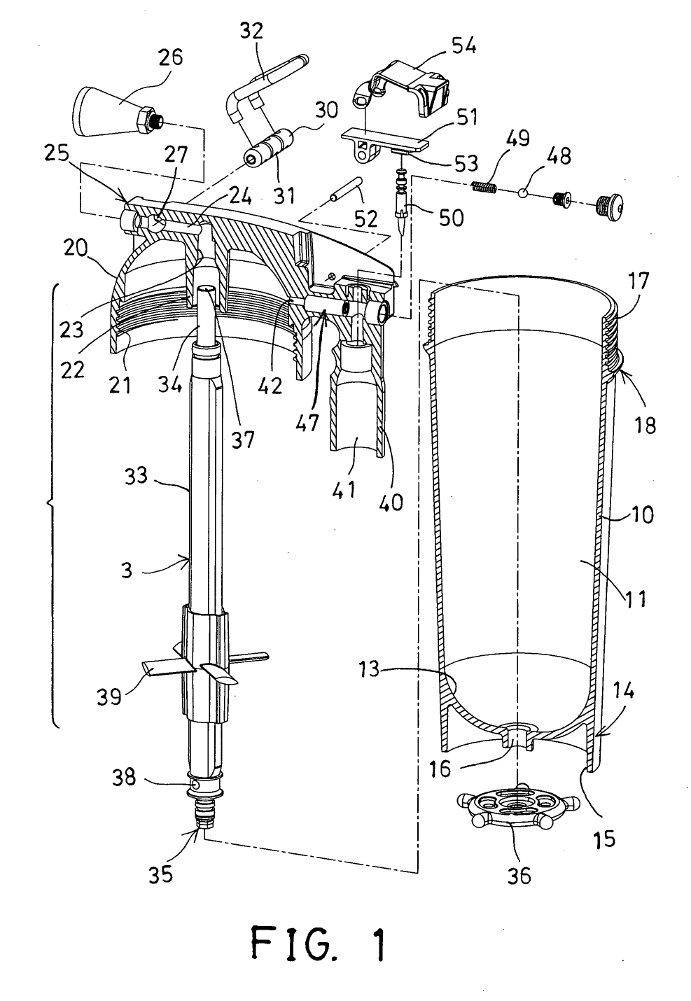

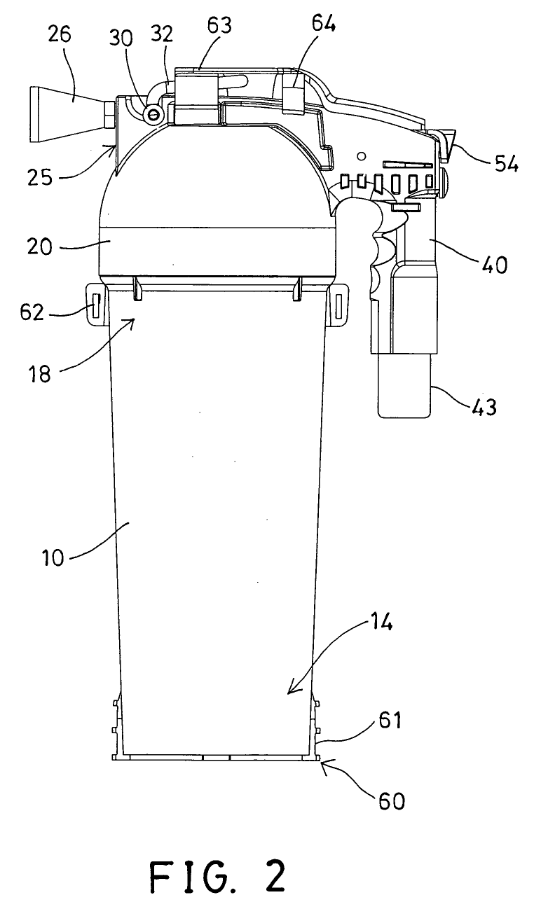

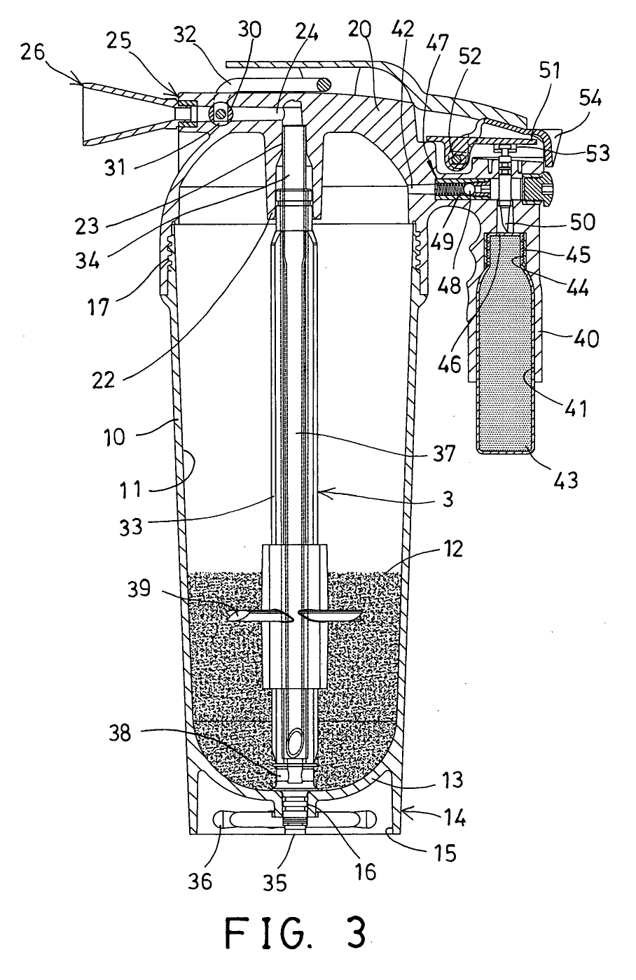

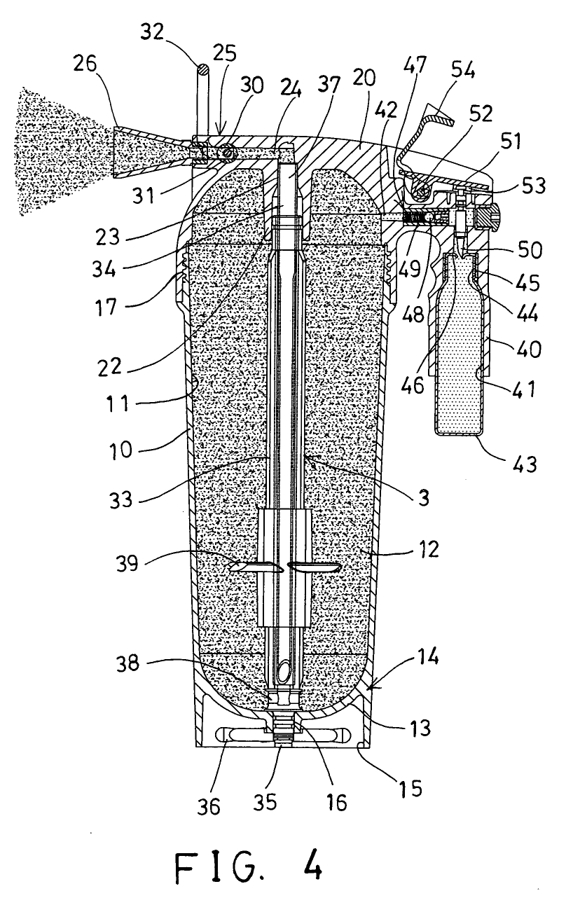

Referring to the drawings, and initially to FIGS. 1-3, a fire extinguisher in accordance with the present invention comprises a container 10 including a chamber 11 formed therein for receiving a powder or dry chemical agent 12 therein (FIGS. 3, 4), and including a curved bottom wall 13 formed or provided in the lower portion 14 of the container 10 for forming a compartment 15 below the bottom wall 13, and including a port 16 formed in the bottom wall 13 and communicating with both the chamber 11 and the compartment 15 of the container 10, and including an outer thread 17 formed in the outer peripheral portion of the upper portion 18 of the container 10 for detachably attaching a cover 20 which may include an inner thread 21 formed therein for engaging with the outer thread 17 of the container 10.

The cover 20 includes a stud 22 extended downwardly therefrom or therein and having a conduit 23 formed therein for communicating with the chamber 11 of the container 10, and includes a passage 24 formed in the front portion 25 thereof and communicating with the conduit 23, and includes a funnel or nozzle 26 attached to the front portion 25 of the cover 20 for allowing the dry chemical agent 12 to flow from the chamber 11 of the container 10 and through the conduit 23 and the passage 24 and then to flow out through the nozzle 26, and includes an orifice 27 laterally formed in the front portion 25 of the cover 20 and intersecting or communicating with the conduit 23 for rotatably receiving a valve member 30, in which the valve member 30 includes a groove 31 formed therein for engaging with the cover 20 and for adjusting the flowing speed or quantity of the dry chemical agent 12 out through the nozzle 26.

For example, the valve member 30 may be rotated relative to the cover 20 for adjusting the relative position or the inclination of the groove 31 of the valve member 30 relative to the conduit 23 of the cover 20 and thus for adjusting the communicating area between the groove 31 of the valve member 30 and the conduit 23 of the cover 20 and thus for adjusting the flowing speed or quantity of the dry chemical agent 12 out through the conduit 23 and the nozzle 26 of the cover 20. A handle 32 may be attached or secured to the valve member 30 for rotating the valve member 30 relative to the cover 20 in order to adjust the flowing speed or quantity of the dry chemical agent 12 out through the conduit 23 and the nozzle 26 of the cover 20.

An agitating means or device 3 includes a rod 33 rotatably received in the chamber 11 of the container 10, and the rod 33 includes an upper portion 34 rotatably attached or engaged into the conduit 23 of the cover 20 and includes a lower portion 35 rotatably and partially engaged out through the port 16 of the bottom wall 13 of the container 10, and secured to a hand wheel 36 which may rotate the rod 33 relative to the container 10 and the cover 20, the rod 33 includes a bore 37 formed therein and communicating with the conduit 23 and the passage 24 of the cover 20, and includes an aperture 38 formed or provided in the lower portion thereof and communicating with the bore 37 of the rod 33 for allowing the dry chemical agent 12 to flow through the aperture 38 and into the bore 37 of the rod 33, and includes a paddle wheel or stirrer or agitator 39 attached or secured to the rod 33 and rotated in concert with the rod 33.

In operation, as shown in FIGS. 3 and 4, the rod 33 and the agitator 39 may be rotated relative to the container 10 and the cover 20 manually with the hand wheel 36 in order to stir or to agitate the dry chemical agent 12 and for preventing the dry extinguishing agent from being hardened into a hardened block and for allowing the dry extinguishing agent to be maintained in a working status or condition that is readily to be blown or carried into the bore 37 of the rod 33 and then to be blown or carried out through the conduit 23 and the nozzle 26 of the cover 20. The valve member 30 may then be rotated relative to the cover 20 in order to adjust the groove 31 of the valve member 30 relative to the conduit 23 of the cover 20 and to adjust the flowing speed or quantity or condition of the dry chemical agent 12 out through the conduit 23 and the nozzle 26 of the cover 20.

The cover 20 includes a hand grip 40 attached thereto or extended outwardly therefrom, and includes a space 41 formed therein, and includes a channel 42 formed therein and communicating with the chamber 11 of the container 10 and the space 41 of the hand grip 40. A bottle 43 is provided for receiving a compressed gas and may include a mouth 44 attached or secured into the space 41 of the hand grip 40 with such as a threading engagement 45 for detachably attaching the bottle 43 to the hand grip 40, the bottle 43 may include a membrane 46 provided or attached to the mouth 44 (FIGS. 3 and 4) for being selectively perforated or pierced (FIG. 4) and for allowing the compressed gas to flow out of the bottle 43 and to flow through the space 41 and the channel 42 of the hand grip 40, and then to flow into the chamber 11 of the container 10.

A check valve 47 is attached or secured in the channel 42 of the hand grip 40, and includes such as a detent 48 and a spring member 49 engaged with the detent 48 for biasing or forcing the detent 48 to selectively close or block the channel 42 of the hand grip 40, in order to limit the compressed gas to flow from the bottle 43 into the chamber 11 of the container 10 and to prevent the dry chemical agent 12 from flowing into the bottle 43. A needle or piercing member 50 is slidably engaged into the space 41 of the hand grip 40 and extended toward the membrane 46 of the bottle 43 (FIG. 3) for respectively breaking or piercing the membrane 46 of the bottle 43 (FIG. 4) and for allowing the compressed gas to flow out of the bottle 43.

A knob or actuating member 51 is rotatably or pivotally coupled to the cover 20 or the hand grip 40 with a pivot axle 52, and includes a pad or anvil 53 attached thereto or extended outwardly therefrom for engaging with the piercing member 50 and for respectively forcing or actuating the piercing member 50 to break or pierce the membrane 46 of the bottle 43 (FIG. 4). A cap 54 may also be rotatably or pivotally coupled to the hand grip 40 with the pivot axle 52 for allowing the cap 54 to shield or to protect the actuating member 51 and for preventing the actuating member 51 from being actuated or operated inadvertently (FIG. 3), and for allowing the actuating member 51 to be actuated or operated only when the cap 54 is pivoted or rotated away from the actuating member 51 (FIG. 4).

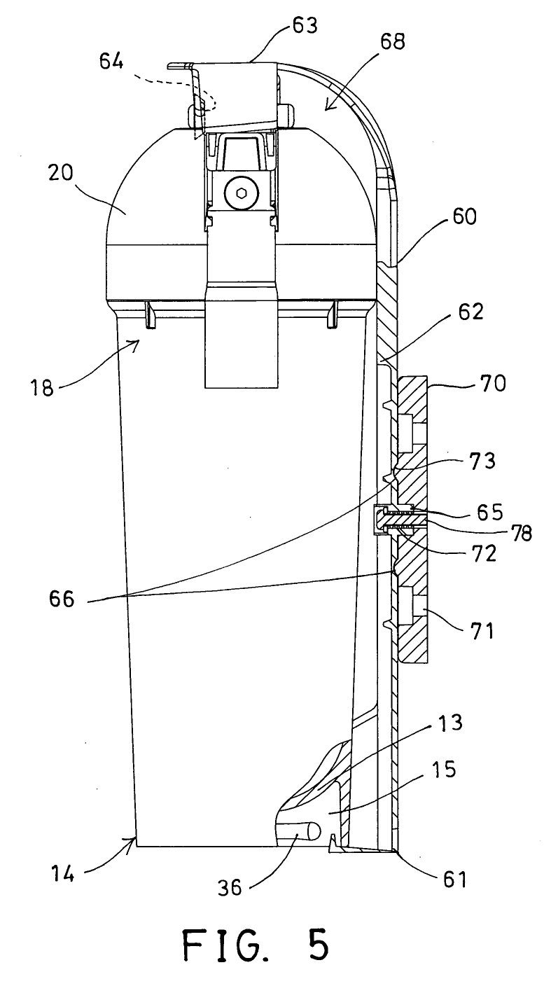

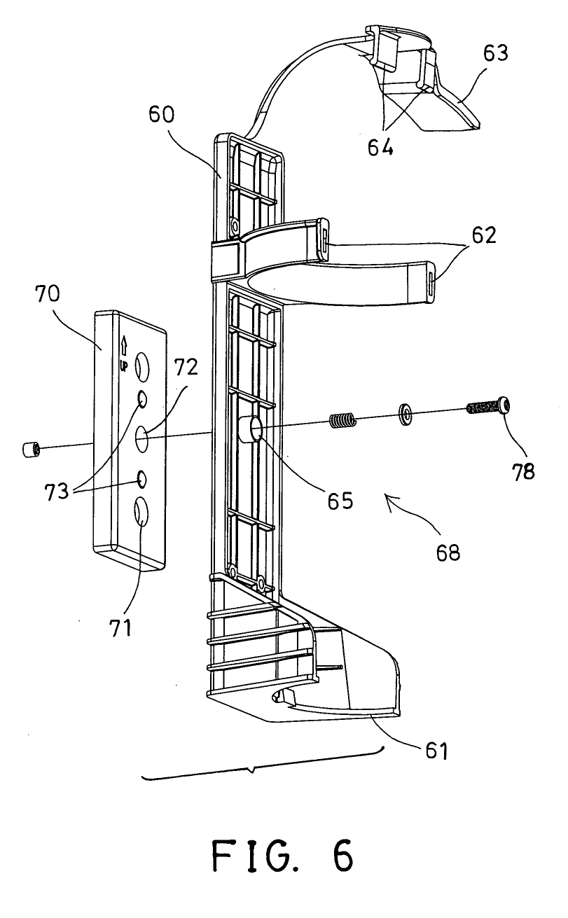

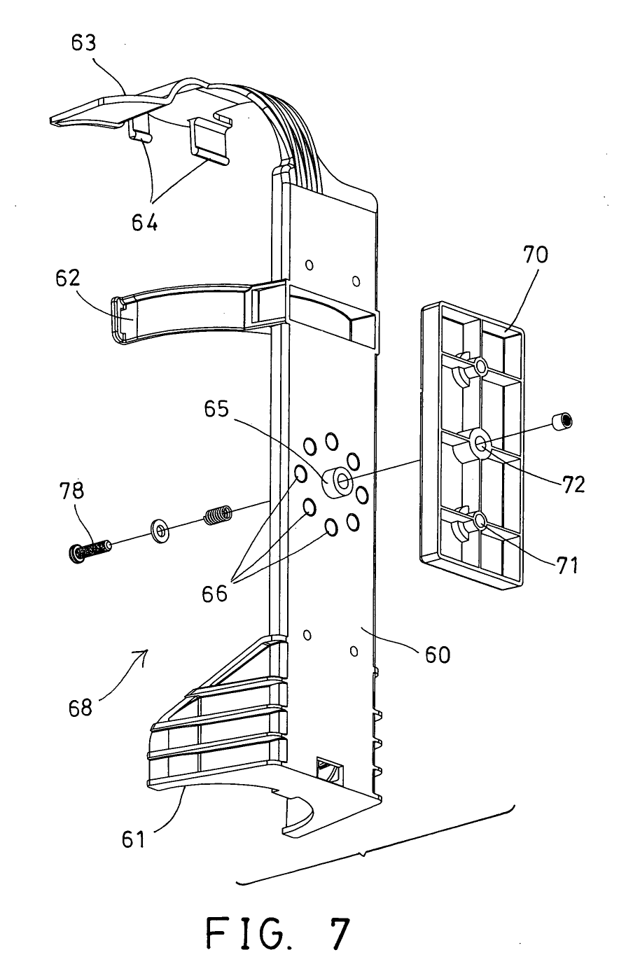

As shown in FIGS. 5-7, the fire extinguisher further includes a bracket or carrier 60 having a lower casing 61 for engaging with the lower portion 14 of the container 10, and includes two arms 62 extended forwardly from the middle portion of the carrier 60 for engaging with the container 10 and anchoring or holding the container 10 to the carrier 60, and includes a shield 63 extended upwardly from the upper portion of the carrier 60 for shielding or covering the handle 32 and for preventing the handle 32 from being actuated or operated inadvertently, and includes one or more (such as two) catches 64 extended downwardly from the shield 63 for engaging with the cover 20 and for solidly anchoring or securing the cover 20 to the carrier 60, and includes a space 68 formed between the lower casing 61 and the arms 62 and the shield 63 for receiving or accommodating the container 10.

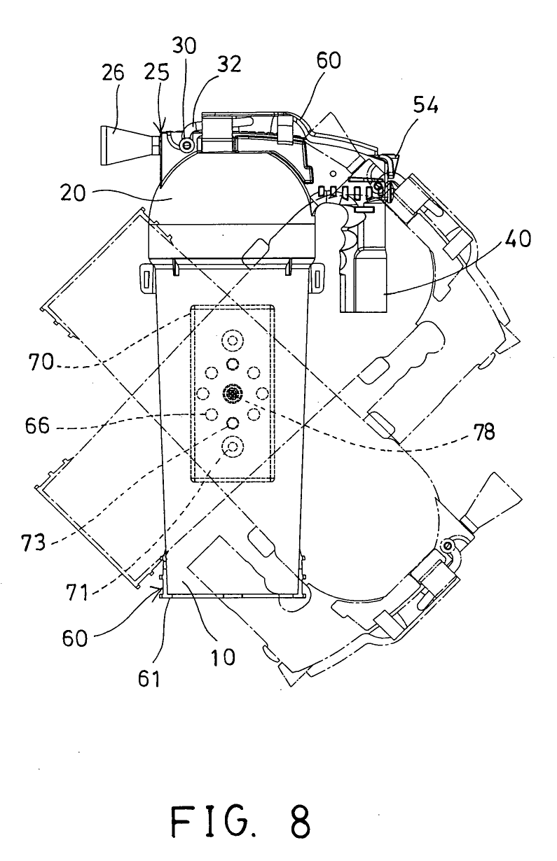

The carrier 60 includes a hub 65 formed or provided in the middle portion of the carrier 60, and includes a number of engaging members 66, such as depressions 66 formed therein and located or arranged around the hub 65. A seat 70 includes one or more (such as two) holes 71 formed therein for engaging with the fasteners (not shown) which may secure the seat 70 to the walls or the supporting surfaces, and includes a central opening 72 formed therein for receiving a fastener or shaft 78 which may secure the carrier 60 to the seat 70, and includes one or more (such as two) engaging members 73, such as projections 73 extended outwardly therefrom for engaging with the engaging members or depressions 66 of the carrier 60, and for allowing the carrier 60 to be rotated and adjusted and secured relative to the seat 70 to any selected angular position by the engagement between the projections 73 and the depressions 66 of the carrier 60 (FIG. 8).

In operation, as shown in FIG. 8, when it is required to stir or to agitate the dry chemical agent 12 for preventing the dry extinguishing agent from being hardened into a hardened block, the container 10 and the carrier 60 may be rotated and adjusted relative to the seat 70 to a selected angular position where the container 10 and the carrier 60 are tilted or inclined relative to the seat 70, for allowing the hand wheel 36 to be exposed and for allowing the hand wheel 36 to be easily rotated or actuated by the users to agitate the dry chemical agent 12 for preventing the dry extinguishing agent from being hardened into a hardened block and for allowing the dry extinguishing agent to be maintained in a working status or condition that is readily to be blown or carried into the bore 37 of the rod 33 and then to be blown or carried out through the conduit 23 and the nozzle 26 of the cover 20.

Accordingly, the fire extinguisher in accordance with the present invention includes an agitating or stirring device for agitating or stirring the dry extinguishing agent and for preventing the dry extinguishing agent from being hardened into a hardened block and for allowing the dry extinguishing agent to be maintained in a readily working status.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fire extinguisher comprising:
a container including a chamber formed therein for receiving a dry chemical agent therein,
a cover attached to an upper portion of said container and including a passage formed therein for allowing the dry chemical agent to flow out through said passage of said cover, and
an agitating device received in said chamber of said container for agitating the dry chemical agent and for preventing the dry extinguishing agent from being hardened.

2. The fire extinguisher as claimed in claim 1, wherein said agitating device includes a rod rotatably received in said chamber of said container, and said rod is partially extended out of said container, and a hand wheel secured to said rod for rotating said rod relative to said container and said cover.

3. The fire extinguisher as claimed in claim 2, wherein said agitating device includes an agitator attached to said rod for being rotated by said hand wheel.

4. The fire extinguisher as claimed in claim 2, wherein said rod includes a bore formed therein, and includes an aperture formed therein and communicating with said bore of said rod for allowing the dry chemical agent to flow through said aperture and into said bore of said rod.

5. The fire extinguisher as claimed in claim 2, wherein said cover includes a conduit formed therein for attaching an upper portion of said rod, and said conduit of said cover is communicating with said passage of said cover.

6. The fire extinguisher as claimed in claim 1, wherein said cover includes an orifice formed therein and communicating with said conduit for receiving a valve member.

7. The fire extinguisher as claimed in claim 6, wherein said valve member is rotatably received in said orifice of said cover and includes a groove formed therein for engaging with said cover and for adjusting a flowing of the dry chemical agent out through said passage of said cover.

8. The fire extinguisher as claimed in claim 1, wherein said cover includes a hand grip extended therefrom, and includes a space formed in said hand grip, and includes a channel formed in said cover and communicating with said chamber of said container and said space of said hand grip, and a bottle for receiving a compressed gas includes a mouth attached to said space of said hand grip with for supplying the compressed gas to said space of said hand grip and said channel of said hand grip and said chamber of said container.

9. The fire extinguisher as claimed in claim 8, wherein a check valve is disposed in said channel of said hand grip to limit the compressed gas to flow from said bottle to said chamber of said container.

10. The fire extinguisher as claimed in claim 8, wherein said bottle includes a membrane attached to the mouth, and a piercing member is slidably engaged into said space of said hand grip and extended toward said membrane of said bottle for piercing said membrane of said bottle and for allowing the compressed gas to flow out of said bottle.

11. The fire extinguisher as claimed in claim 10, wherein an actuating member is pivotally coupled to said cover with a pivot axle and engaged with said piercing member for actuating said piercing member to pierce said membrane of said bottle.

12. The fire extinguisher as claimed in claim 11, wherein a cap is pivotally coupled to said hand grip with said pivot axle for shielding and protecting said actuating member and for preventing said actuating member from being operated inadvertently.

13. A fire extinguisher comprising:
a seat including at least one first engaging member provided therein,
a container including a chamber formed therein for receiving a dry chemical agent therein,
a cover attached to said container and including a passage formed therein for allowing the dry chemical agent to flow out through said passage of said cover, and
a carrier rotatably attached to said seat with a shaft and including a space formed therein for receiving said container, and including a plurality of second engaging member provided around said shaft for engaging with said at least one first engaging member of said seat and for adjustably securing said carrier and said container to said seat at selected angular positions.

14. The fire extinguisher as claimed in claim 13, wherein said carrier includes a lower casing and two arms for forming said space of said carrier.

15. The fire extinguisher as claimed in claim 13, wherein said carrier includes an upwardly extending shield having at least one catch for engaging with said cover and for securing said cover to said carrier.

16. The fire extinguisher as claimed in claim 13, wherein a rod is rotatably received in said chamber of said container and partially extended out of said container, and a hand wheel secured to said rod for rotating said rod relative to said container and said cover, and an agitator attached to said rod for being rotated by said hand wheel.

17. The fire extinguisher as claimed in claim 16, wherein said rod includes a bore formed therein, and includes an aperture formed therein and communicating with said bore of said rod for allowing the dry chemical agent to flow through said aperture and into said bore of said rod.

18. The fire extinguisher as claimed in claim 16, wherein said cover includes a conduit formed therein for attaching an upper portion of said rod, and said conduit of said cover is communicating with said passage of said cover.
